(19) United States
(12) Patent Application Publication
(10) Pub. No.: US 2026/0154858 A1
(43) Pub. Date: Jun. 4, 2026

(54) SCENE GRAPH-BASED COMPLEX VIDEO GENERATION SYSTEM AND METHOD

(71) Applicant: Korea Electronics Technology Institute, Seongnam-si (KR)

(72) Inventor: Han Mu PARK, Seongnam-si (KR)

(73) Assignee: Korea Electronics Technology Institute, Seongnam-si (KR)

(21) Appl. No.: 19/398,454

(22) Filed: Nov. 24, 2025

(30) Foreign Application Priority Data
Nov. 29, 2024 (KR) 10-2024-0175511

(51) Int. Cl. G06T 11/00; G06T 13/00

(52) U.S. Cl. CPC G06T 11/00; G06T 13/00

(57) ABSTRACT

Provided are a system and a method for creating a complex video based on a scene graph. The video creation system according to an embodiment may include a text encoder configured to embed a video caption containing an explanation of a video to create; an image encoder configured to extract a feature map from an input image; a scene graph embedding unit configured to embed a scene graph related to the input image; and a video creator configured to create a video including the input image from the video caption embedding information, the feature map of the input image, and the scene graph embedding information. Accordingly, a natural video may be created in various input circumstances.

### CROSS-REFERENCE TO RELATED APPLICATION(S) AND CLAIM OF PRIORITY

This application is based on and claims priority under 35 U.S.C. § 119 to Korean Patent Application No. 10-2024-0175511, filed on Nov. 29, 2024, in the Korean Intellectual Property Office, the disclosure of which is herein incorporated by reference in its entirety.

### BACKGROUND

### Field

The disclosure relates to artificial intelligence (AI)-based video creation, and more particularly, to a method for creating complex scenes by understanding relationships between objects in a video by using images, video captions, and scene graphs.

### Description of Related Art

Text-video conversion technologies are for creating desired videos based on texts inputted by users, and automatically create visual contents according to explanation of given texts and provide various video data.

However, videos may include complex backgrounds, various objects, movements of objects, and mutual relationships between objects, so that there is a difficulty to creating a desired video simply by using texts as input. This is because it is difficult to exactly represent detailed relationships between objects in a video or fine movements of objects only with text input, and a created video may not semantically match the input texts.

To solve this problem, there is a method that additionally receives an image as input and extracts and predicts key points of objects in the image, and creates a video based on visual appearance of image objects and the extracted key point information. However, this method has limitations in fully reflecting complex interactions or relationships between objects. In a complex scene in which a plurality of objects interact with each other, movements between objects and detailed interaction may be dynamically changed with time, which may lead to limitations in faithfully reproducing complex temporal relationships between objects in the process of creating a video.

### SUMMARY

The disclosure has been developed in order to solve the above-described problems, and an object of the disclosure is to provide, as a solution to create a continuous video more precisely and more consistently with a single image or several images, a system and a method for creating a video by understanding objects included in an image according to relationship information defined in a scene graph by using the image and scene graph data.

According to an embodiment of the disclosure to achieve the above-described object, a video creation system may include: a text encoder configured to embed a video caption containing an explanation of a video to create; an image encoder configured to extract a feature map from an input image; a scene graph embedding unit configured to embed a scene graph related to the input image; and a video creator configured to create a video including the input image from the video caption embedding information, the feature map of the input image, and the scene graph embedding information.

The video creator may create the video in which the input image is included in a frame of a specific sequence number.

The video creator may receive and use additional information on which frame the input image corresponds to in the video to create in creating the video.

The scene graph embedding unit may embed location information of objects existing in the input image and relationship information between the objects, which are recorded on the scene graph.

The image encoder may receive objects extracted from the input image, as an input, based on the location information of the objects which is recorded on the scene graph, may extract the feature maps of the objects, and may transfer the feature maps to the video creator.

The relationship information between the objects which is recorded on the scene graph may include information on a relationship location area which is an area where relationships are established.

The relationship location area may be determined by a relationship subject area which is an area occupied by a subject of the relationship among the objects, and a relationship object area which is an area occupied by an object of the relationship among the objects.

The relationship location area may include: when the relationship subject area and the relationship object area do not overlap, an area that is located between the relationship subject area and the relationship object area; when the relationship subject area and the relationship object area overlap in part, a partially overlapping area; and, when one of the relationship subject area and the relationship object area includes the other one, an area of the other one included in the one.

The video creator may include an AI model having a self-attention layer on a video frame basis based on a transformer structure, and the self-attention layer may process by concatenating the feature map of the input image to a feature map of a frame image corresponding to itself.

According to another aspect of the disclosure, there is provided a video creation method including: embedding a video caption containing an explanation of a video to create; extracting a feature map from an input image; embedding a scene graph related to the input image; and creating a video including the input image from the video caption embedding information, the feature map of the input image, and the scene graph embedding information.

According to another aspect of the disclosure, there is provided a training system including: a video creation system configured to create a video including an input image based on AI; and a training unit configured to calculate an error between a video created from a training dataset by the video creation system, and an actual video, and to fine-tune the video creation system, wherein the video creation system includes: a text encoder configured to embed a video caption containing an explanation of a video to create; an image encoder configured to extract a feature map from an input image; a scene graph embedding unit configured to embed a scene graph related to the input image; and a video creator configured to create a video including the input image from the video caption embedding information, the feature map of the input image, and the scene graph embedding information.

As described above, according to embodiments of the disclosure, by using a scene graph in creating a continuous video with a single image or several images, relationship between objects may be clearly understood, and, by creating a dynamic video based on the relationships, complex interactions between the objects may be efficiently modeled, and a natural video may be created in various input circumstances.

Other aspects, advantages, and salient features of the invention will become apparent to those skilled in the art from the following detailed description, which, taken in conjunction with the annexed drawings, discloses exemplary embodiments of the invention.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a view illustrating a scene graph-based video creation system according to an embodiment of the disclosure;

FIGS. 2A and 2B are views illustrating an example of a pair of image and scene graph;

FIG. 3 is a view illustrating relationship location areas;

FIG. 4 is a view illustrating a scene graph-based video creation method according to another embodiment of the disclosure; and

FIG. 5 is a view illustrating a training method of a video creation system according to still another embodiment of the disclosure.

### DETAILED DESCRIPTION

Hereinafter, the disclosure will be described in more detail with reference to the accompanying drawings.

Embodiments of the disclosure present a system and a method for creating a complex video based on a scene graph. The disclosure relates to a technique for creating complex scenes by understanding relationships between objects in an image by using images, video captions, scene graphs.

Compared to related-art methods of creating videos by using only images and video captions, a method according to an embodiment of the disclosure may accurately grasp location information of objects and relationship information between objects by additionally using a scene graph, and may create a sophisticated video based on the aforementioned information.

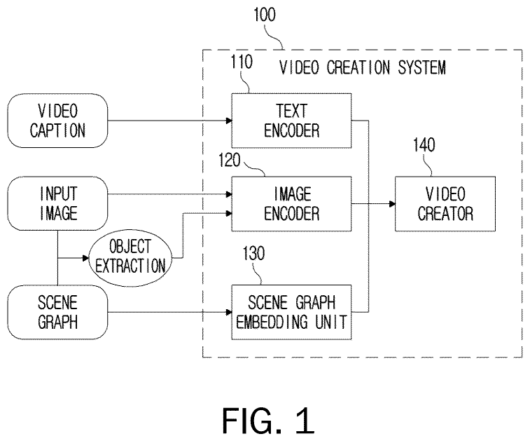

FIG. 1 is a view illustrating a configuration of a scene graph-based video creation system according to an embodiment of the disclosure. The video creation system 100 according to an embodiment may create a video by integrating an input image including various objects, a video caption, and a scene graph.

As shown in FIG. 1, the video creation system 100 performing the above-described function according to an embodiment may be configured by including a text encoder 110, an image encoder 120, a scene graph embedding unit 130, and a video creator 140.

The text encoder 110 is configured to embed a video caption and to input the video caption into the video creator 140. The video caption refers to a text containing contents/explanations on the video that the video creation system 100 is to create. The video caption may be generated by a user directly inputting.

The image encoder 120 is configured to extract a feature map from the input image and to input the feature map into the video creator 140. A target to be encoded by the image encoder 120 may include objects included in the input image in addition to the entire input image. That is, the image encoder 120 may extract a feature map even about object areas of the input image, and may input the feature map into the video creator 140. The objects may be extracted from the input image based on location information of the objects that is recorded on the scene graph.

The scene graph embedding unit 130 is configured to embed contents of the scene graph on the input image and to input the contents of the scene graph into the video creator 140. The scene graph may represent/record location information of the objects existing in the input image and relationship information between the objects.

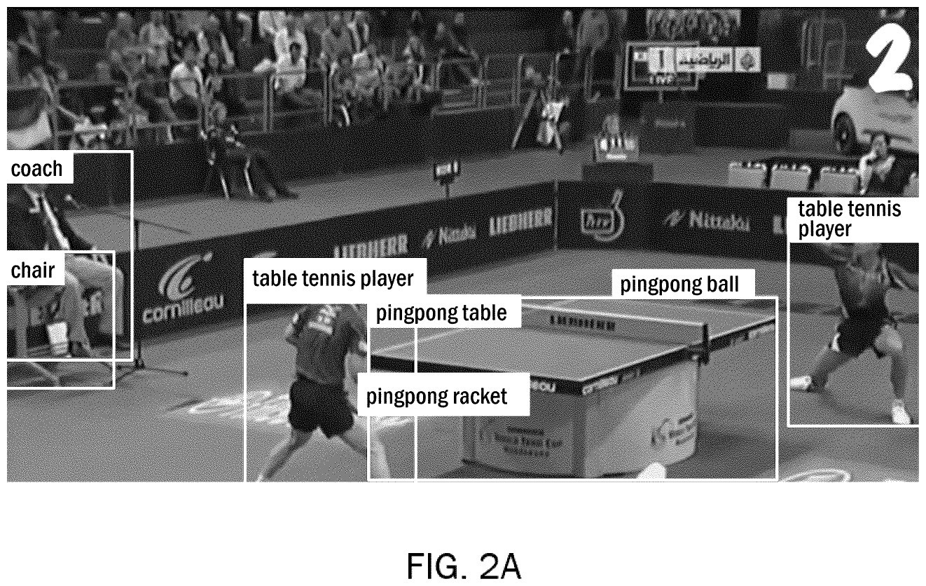

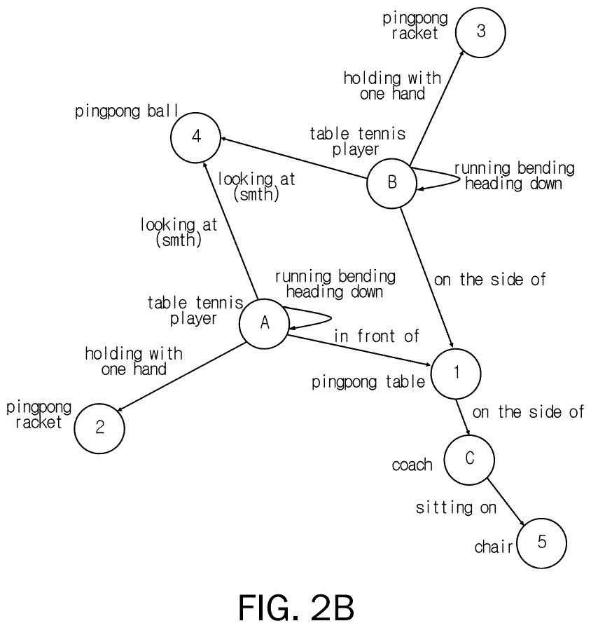

FIGS. 2A and 2B illustrate an example of a pair of image and scene graph. An input image is presented in FIG. 2A and a scene graph on the input image presented in FIG. 2A is presented in FIG. 2B.

The scene graph may record location information of the objects included in the image, and may also record relationships or state information between the objects as shown in FIG. 2B. As described above, the scene graph may clearly define the location of each object in the image and relationships between the objects, and may express physical distances, interactions, states of specific actions in various forms.

For example, the scene graph may show whether two objects are located close to each other, perform specific interaction, or are performing specific actions. As many scene graphs as the number of frames to be crated should be given as input.

In an embodiment of the disclosure, information on relationship location areas for specifying specific areas where relationships between objects are established may be added to the scene graph as relationship information between the objects.

The relationship location area may refer to an area of a location where a relationship subject and a relationship object have relationships when one of the objects is a relationship subject and another object is a relationship object. The relationship location area may be determined by a relationship subject area which is an area occupied by the relationship subject, and a relationship object area which is an area occupied by the relationship object.

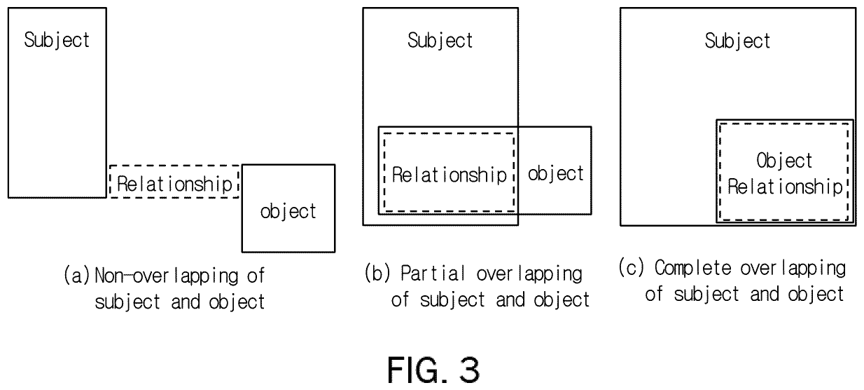

The relationship location areas may be classified into three types as shown in FIG. 3. One type is the relationship location area where the relationship subject area and the relationship object area do not overlap and is determined by an area that is located between the relationship subject area and the relationship object area ((a) of FIG. 3). Another type is the relationship location area where the relationship subject area and the relationship object area overlap in part, and is determined by a partially overlapping area ((b) of FIG. 3). The other type is the relationship location area where one of the relationship subject area and the relationship object area includes the other one, and is determined by the area of the other one included in the one area.

Referring back to FIG. 1, the video creator 140 may receive a video caption embedding vector which is generated by the text encoder 110, the feature map of the input image and the feature maps of the objects which are extracted by the image encoder 120, a scene graph embedding vector which is generated by the scene graph embedding unit 130, information on which frame the input image should be included in within the video to be created, and may create a video in which the input image is included in the frame with the designated sequence number.

The input image may be comprised of a single image or a plurality of images. In the latter case, the input images may be adjacent to one another in the video but need not be. In either case, information on which frames the input images should be included in within the video to be created should be given to the video creator 140. This information may be generated by a user directly inputting, may be predetermined, or may be generated through an automatic generation tool.

The video creator 140 may be implemented by an AI model that is based on a transformer structure and has a self-attention layer on a video frame basis. In order to increase a similarity between the created video frames and the input image, the input image frame is processed in a way that it is concatenated to the self-attention layer of another frame before the self-attention layer. That is, the self-attention layer may process by concatenating the feature map of the input image to the feature map of the frame image corresponding to itself, and this process may be expressed by the following equations:

Q=W^{Q}zᵢ, K=W^{K}[zᵢ,z_{g}], V=W^{V}[zᵢ,z_{g}],

Attention(Q,K,V)=Softmax(QK^{T})V,

where W^{Q}, W^{K}, W^{V} are trainable projection matrices, [⋅] is a concatenate operator, and zᵢ, z_{g} are a feature map of the i-th frame and a feature map of an input image, respectively.

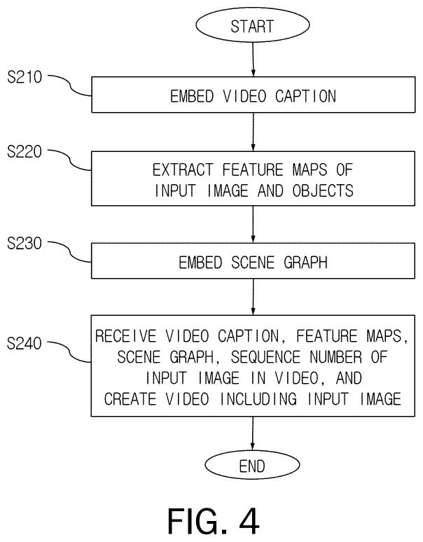

FIG. 4 is a flowchart illustrating a scene graph-based video creation method according to another embodiment of the disclosure.

As shown in FIG. 4, in order to create a video, the text encoder 110 may embed a video caption and generate an embedding vector (S210), the image encoder 120 may extract a feature map of the input image and feature maps of objects (S220), and the scene graph embedding unit 130 may embed a scene graph related to the input image and generate an embedding vector (S230).

The video creator 140 may receive the video caption embedding vector generated at step S210, the feature maps extracted at step S220, the scene graph embedding vector generated at step S230, and information on which frame the input image should be included in within the video to be created, and may create a video in which the input image is included in the frame of the designated sequence number (S240).

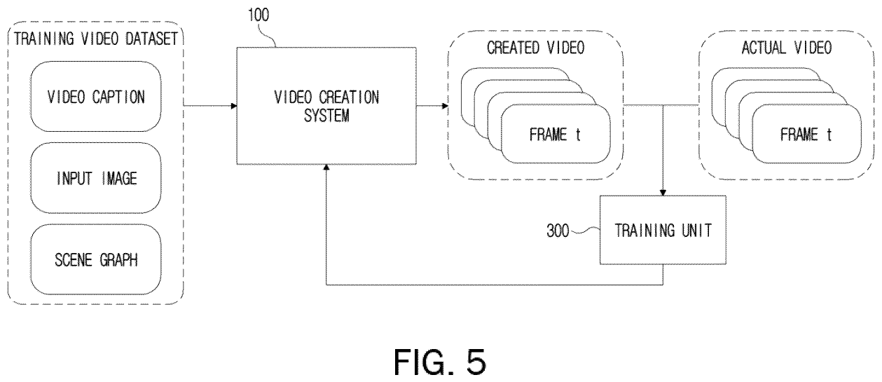

A training process of the video creation system 100 according to an embodiment of the disclosure will be described in detail with reference to FIG. 5. FIG. 5 is a view to explain a training method of the scene graph-based video creation system 100.

When a video is created by inputting a video caption of a training dataset, an input image, and a scene graph into the video creation system 100 to train the video creation system 100, a training unit 300 may calculate an error between the video created by the video creation system 100 and an actual video (GT), and may fine-tune parameters of the video creation system 100 to reduce the error.

In this case, the input image of the training data set may be extracted from frames constituting the actual video and may be utilized.

Up to now, the scene graph-based video creation system and method for creating a complex video have been described in detail with reference to preferred embodiments.

In the above embodiments, by using a scene graph in creating a continuous video with a single image or several images, relationship between objects may be clearly understood, and, by creating a dynamic video based on the relationships, complex interactions between the objects may be efficiently modeled, and a natural video may be created in various input circumstances.

The technical concept of the disclosure may be applied to a computer-readable recording medium which records a computer program for performing the functions of the apparatus and the method according to the present embodiments. In addition, the technical idea according to various embodiments of the disclosure may be implemented in the form of a computer readable code recorded on the computer-readable recording medium. The computer-readable recording medium may be any data storage device that can be read by a computer and can store data. For example, the computer-readable recording medium may be a read only memory (ROM), a random access memory (RAM), a CD-ROM, a magnetic tape, a floppy disk, an optical disk, a hard disk drive, or the like. A computer readable code or program that is stored in the computer readable recording medium may be transmitted via a network connected between computers.

In addition, while preferred embodiments of the present disclosure have been illustrated and described, the present disclosure is not limited to the above-described specific embodiments. Various changes can be made by a person skilled in the at without departing from the scope of the present disclosure claimed in claims, and also, changed embodiments should not be understood as being separate from the technical idea or prospect of the present disclosure.

What is claimed is:

1. A video creation system comprising:
a text encoder configured to embed a video caption containing an explanation of a video to create;
an image encoder configured to extract a feature map from an input image;
a scene graph embedding unit configured to embed a scene graph related to the input image; and
a video creator configured to create a video comprising the input image from the video caption embedding information, the feature map of the input image, and the scene graph embedding information.

2. The video creation system of claim 1, wherein the video creator is configured to create the video in which the input image is included in a frame of a specific sequence number.

3. The video creation system of claim 2, wherein the video creator is configured to receive and use additional information on which frame the input image corresponds to in the video to create in creating the video.

4. The video creation system of claim 1, wherein the scene graph embedding unit is configured to embed location information of objects existing in the input image and relationship information between the objects, which are recorded on the scene graph.

5. The video creation system of claim 4, wherein the image encoder is configured to receive objects extracted from the input image, as an input, based on the location information of the objects which is recorded on the scene graph, to extract the feature maps of the objects, and to transfer the feature maps to the video creator.

6. The video creation system of claim 4, wherein the relationship information between the objects which is recorded on the scene graph comprises information on a relationship location area which is an area where relationships are established.

7. The video creation system of claim 6, wherein the relationship location area is determined by a relationship subject area which is an area occupied by a subject of the relationship among the objects, and a relationship object area which is an area occupied by an object of the relationship among the objects.

8. The video creation system of claim 7, wherein the relationship location area comprises:
when the relationship subject area and the relationship object area do not overlap, an area that is located between the relationship subject area and the relationship object area;
when the relationship subject area and the relationship object area overlap in part, a partially overlapping area; and
when one of the relationship subject area and the relationship object area comprises the other one, an area of the other one included in the one.

9. The video creation system of claim 1, wherein the video creator comprises an AI model having a self-attention layer on a video frame basis based on a transformer structure, and
wherein the self-attention layer processes by concatenating the feature map of the input image to a feature map of a frame image corresponding to itself.

10. A video creation method comprising:
embedding a video caption containing an explanation of a video to create;
extracting a feature map from an input image;
embedding a scene graph related to the input image; and
creating a video comprising the input image from the video caption embedding information, the feature map of the input image, and the scene graph embedding information.

11. A training system comprising:
a video creation system configured to create a video comprising an input image based on AI; and
a training unit configured to calculate an error between a video created from a training dataset by the video creation system, and an actual video, and to fine-tune the video creation system,
wherein the video creation system comprises:
a text encoder configured to embed a video caption containing an explanation of a video to create;
an image encoder configured to extract a feature map from an input image;
a scene graph embedding unit configured to embed a scene graph related to the input image; and
a video creator configured to create a video comprising the input image from the video caption embedding information, the feature map of the input image, and the scene graph embedding information.
